(19) United States
(12) Patent Application Publication
(10) Pub. No.: US 2004/0089830 A1
(43) Pub. Date: May 13, 2004

(54) Manually operated hydraulic valve with a position detent

(75) Inventor: Yakov Beyrak, Glenview, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: HydraForce, Inc., Lincolnshire, IL (US)

(21) Appl. No.: 10/663,063

(22) Filed: Sep. 16, 2003

Related U.S. Application Data
(60) Provisional application No. 60/411,462, filed on Sep. 17, 2002.

(51) Int. Cl. F16K 35/00

(52) U.S. Cl. 251/90; 251/111

(57) ABSTRACT

Disclosed is a valve having one or more ports. The valve comprises a spool slidably disposed within the valve and a generally circular retainer disposed so as to prevent the spool from moving along an axis of the valve. The retainer is capable of opening so as to permit the spool to move along the axis of the valve.

### CROSS-REFERENCE TO RELATED PATENT APPLICATIONS

This patent application claims the benefit of priority to U.S. Provisional Application No. 60/441,462, filed Sep. 17, 2002, entitled “MANUALLY OPERATED HYDRAULIC VALVE WITH A POSITION DETENT,” which is incorporated in its entirety herein by reference.

### FIELD OF THE INVENTION

This invention relates in general to hydraulic valves and, more particularly, to a cartridge style, manually operated hydraulic valve.

### BACKGROUND OF THE INVENTION

Numerous manually operated valves are known in the art. Often a valve is installed in an environment where it is subjected to vibration or other conditions, which can have the tendency to move the valve from a selected position. It is desired to provide a valve, which includes a structure to help maintain the valve in the selected position.

### SUMMARY OF THE INVENTION

The invention provides a valve having one or more ports. The valve can comprise a spool slidably disposed within the valve and a generally circular retainer disposed so as to prevent the spool from moving along an axis of the valve. The retainer is capable of opening so as to permit the spool to move along the axis of the valve. The valve can also include a coupling member slidably disposed within the valve and coupled to the spool, the coupling member having an annular groove for receiving the generally circular retainer. A guide member can be provided that is fixed within the valve adjacent to the coupling member. The guide member can be disposed with a small clearance to the generally circular retainer such that when the coupling member is subjected to a force, the generally circular retainer comes into contact with the guide member. The guide member can prevent any further movement of the generally circular retainer. In response to the force, the coupling member can move so that the guide member pushes the retainer to open and to leave the annular groove of the coupling member, thereby permitting the spool to move.

In another aspect of the invention, an adaptor can be provided that is fixed within the valve adjacent to the coupling member. The adaptor can be disposed with a small clearance to the generally circular retainer such that when the coupling member is subjected to a force, the generally circular retainer comes into contact with the adaptor. The adaptor can prevent any further movement of the generally circular retainer. In response to the force, the coupling member can move so that the adaptor forces the retainer to open and to leave the annular groove of the coupling member, thereby permitting the spool to move.

The invention can provide a manually operated hydraulic valve that includes a simple, inexpensive detent mechanism. These and other features of the present invention will become apparent to one of ordinary skill in the art upon reading the detailed description, in conjunction with the accompanying drawings.

### BRIEF DESCRIPTION OF THE DRAWINGS

FIG. 1 is a perspective view of an embodiment of a hydraulic valve according to the present invention, shown in a neutral position.

FIG. 2 is a cross-sectional view of the hydraulic valve of FIG. 1, shown in a neutral position.

FIG. 3 is a cross-sectional view of the hydraulic valve of FIG. 1, shown in a first shifted position when its knob is pulled up.

FIG. 4 is a cross-sectional view of the hydraulic valve of FIG. 1, shown in a second shifted position when its knob is pushed down.

FIG. 5 is a top view of the retainer used for the hydraulic valve of FIG. 1.

FIG. 6 is an enlarged fragmentary cross-sectional view of another embodiment of a hydraulic valve according to the present invention.

### DETAILED DESCRIPTION OF EMBODIMENTS OF THE INVENTION

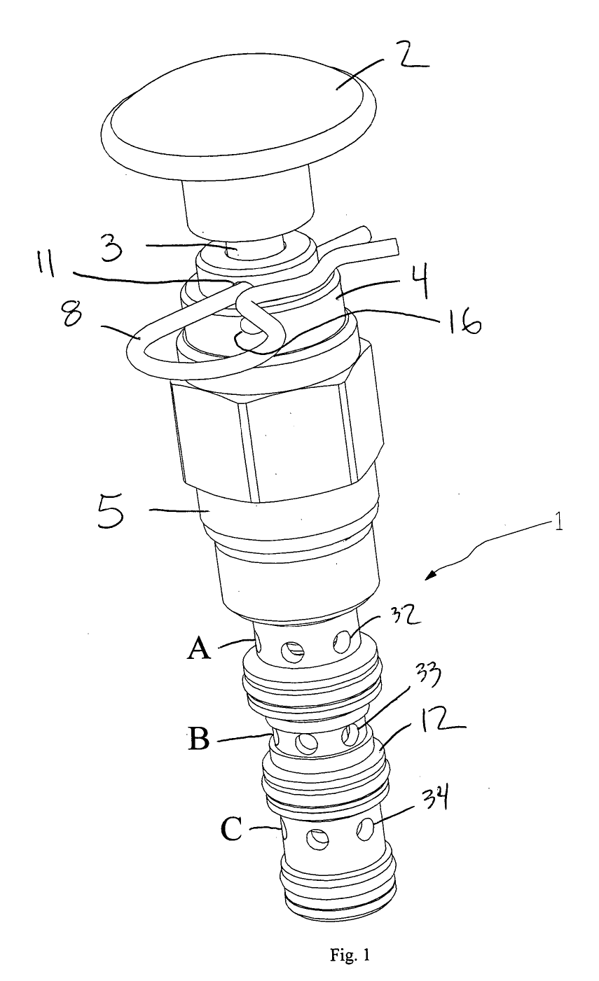

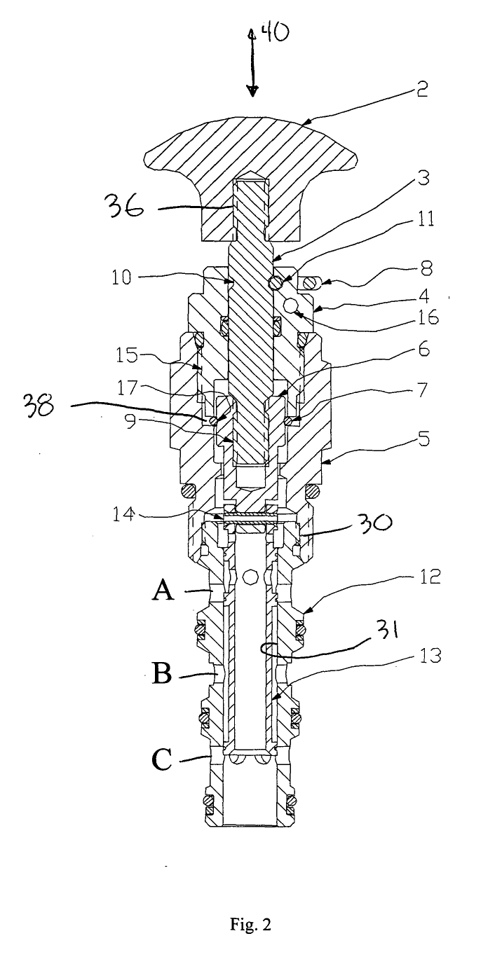

Various embodiments of the invention will now be described. Referring to FIGS. 1 and 2, a hydraulic valve 1 can include an adaptor 5 and a cage 12, connected to each other by a thread 30, and a spool 13 slidable within a bore 31 of the cage 12. The cage 12 has a first port A, which includes a first set 32 of radial holes, a second port B, which includes a second set 33 of radial holes and a third port C, which includes a third set 34 of radial holes. The spool 13 is shown in a neutral position wherein the spool 13 prevents fluid from passing between the first port A and the second port B. A guide 4 is secured to the adaptor 5 by a thread 15. The spool 13 is connected to a coupling 6 by a pin 14. The coupling 6 is connected by a thread 9 to a stem 3. Both the coupling 6 and the stem 3 are slidable within bores of the guide 4 and the adaptor 5. A knob 2 is attached to the stem 3 by a thread 36 or any other suitable means.

The coupling 6 is provided with a groove 17, which receives tightly a circular retainer 7 disposed between the guide 4 and the adaptor 5. There is a very small axial clearance between the retainer 7, the guide 4 and the adaptor 5. There is a lateral clearance 38 between the retainer 7 and the adaptor 5. The clearances allow the retainer 7 to open radially while still substantially limiting movement of the retainer 7 along a longitudinal valve axis 40.

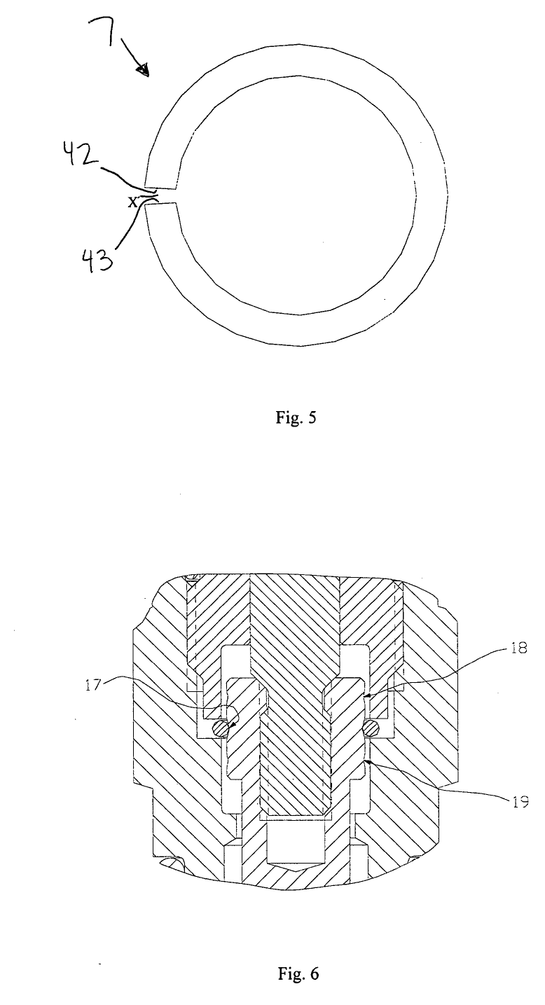

The retainer 7 (see FIG. 5) is preferably made from music wire, carbon spring steel or any other spring material. There is a gap X defined by a pair of ends 42, 43 of the retainer 7 so that the retainer 7 is generally C-shaped. When the retainer 7 opens, it changes its shape so that the gap X increases. When the retainer 7 closes from an open position, it returns toward its original shape with the gap X moving to its original size.

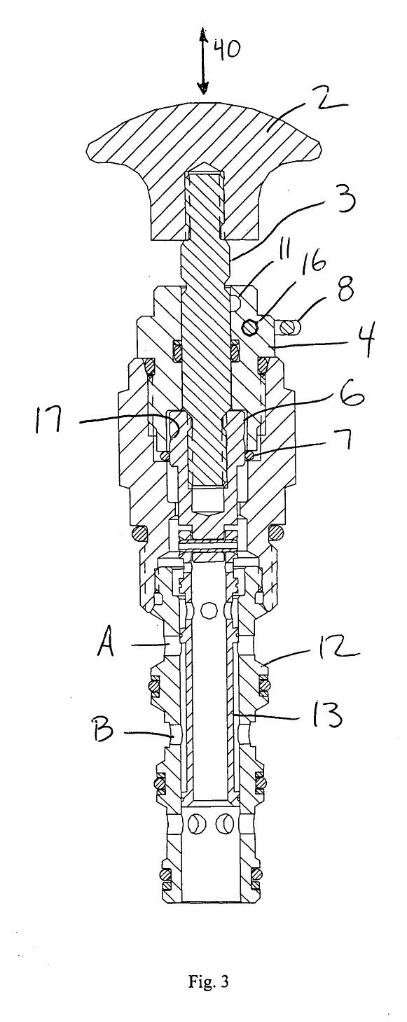

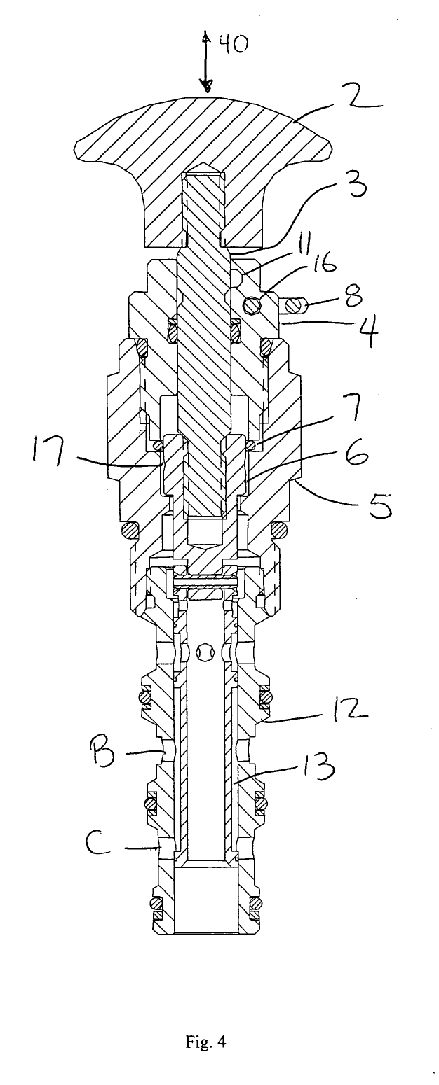

Referring to FIGS. 1 and 2, the guide 4 is provided with first and second holes 11, 16 to receive a locking device, such as a hitch pin clip 8, for example. The first hole 11 is for receiving the hitch pin clip 8 to lock the valve in a neutral position. The second hole 16 is for storing the hitch pin clip 8 when it is not used for locking the valve in the neutral position. In FIGS. 1 and 2, the hitch pin clip 8 is shown as installed in the first hole 11 and in FIGS. 3 and 4 as installed in the second hole 16. The stem 3 is provided with a groove 10 used in conjunction with the hole 11 of the guide 4 to lock the valve in the neutral position by the hitch pin clip 8.

In other embodiments, the stem can include a groove arranged such that the locking device can lock the valve in a shifted position, for example. In yet other embodiments, the stem can include a plurality of grooves arranged to lock the valve in any of a plurality of positions, such as, a neutral position and a shifted position or a neutral position and a pair of shifted positions, for example.

Referring to FIG. 3, in operation, the hitch pin clip 8 is shown removed from the first hole 11 and inserted into the second hole 16. When the knob 2 is pulled up along the longitudinal valve axis 40, and thus moved away from the guide 4, the force is transferred through the stem 3 to the coupling 6 and the retainer 7. The guide 4 prevents the retainer 7 from moving up along the valve axis 40 but allows the retainer 7 to move outwardly such that the retainer 7 can open radially and slide off of the groove 17 of the coupling 6. The coupling 6 can move up until it stops against the guide 4 with the spool 13 taking a first position relative to the cage 12, as shown in FIG. 3. In the first position, the spool 13 permits fluid to flow between the first port A and the second port B. After releasing the knob 2, the coupling 6 and the spool 13 are retained in the first position by the engagement of the retainer 7 and the coupling 6.

Referring to FIG. 4, when the knob 2 is pushed down along the longitudinal valve axis 40, and thus toward the guide 4, the force is transferred through the stem 3 to the coupling 6 and the retainer 7. The adaptor 5 prevents the retainer 7 from moving down but allows the retainer 7 to move radially outwardly so that the retainer 7 can open radially and slide off of the groove 17 of the coupling 6. The coupling 6 can move down until it stops against the adaptor 5 with the spool 13 taking a second position relative to the cage 12, as shown in FIG. 4. In the second position, the spool 13 permits fluid to flow between the second port B and the third port C. After releasing the knob 2, the coupling 6 and the spool 13 are retained in the second position by the engagement of the retainer 7 and the coupling 6.

FIG. 6 shows another embodiment of the present invention. In this embodiment, the coupling 6 is provided with additional grooves 18, 19, which are slightly less deep than the groove 17 of the valve of FIG. 1. The grooves 18, 19 serve to increase the gripping force of the retainer 7, when the retainer 7 slides into them, to hold the coupling 6 and, thus, to retain the coupling 6 and the spool 13 in the first and second positions of the valve.

The present invention is not limited to the shown and described three position valve having a neutral position and two shifted positions but can also be applied to a two position valve having a neutral position and only one shifted position, achieved either by pulling or pushing the knob 2, for example.

Although this invention has been shown and described with respect to detailed, exemplary embodiments thereof, it should be understood by those skilled in the art that various changes in form and detail may be made without departing from spirit and scope of this invention.

What is claimed is:

1. A valve having one or more ports, the valve comprising:
a spool slidably disposed within the valve; and
a retainer disposed so as to prevent the spool from moving along an axis of the valve, the retainer being capable of moving to an open position so as to permit the spool to move along the axis of the valve.

2. The valve of claim 1, wherein the retainer is generally circular.

3. The valve of claim 2, further comprising a coupling member slidably disposed within the valve and coupled to the spool, the coupling member having an annular groove for receiving the generally circular retainer.

4. The valve of claim 3, further comprising a guide member fixed within the valve adjacent to the coupling member and with a small clearance to the generally circular retainer, such that when the coupling member is subjected to a force, the generally circular retainer comes into contact with the guide member and the guide member prevents any further movement of the generally circular retainer along the axis of the valve.

5. The valve of claim 4, wherein the retainer includes a pair of ends that define a gap therebetween.

6. The valve of claim 5, wherein in response to the force, the coupling member moves and the retainer moves to the open position, thereby leaving the annular groove of the coupling member and permitting the spool to move.

7. The valve of claim 3, further comprising an adaptor fixed within the valve adjacent to the coupling member and with a small clearance to the generally circular retainer, such that when the coupling member is subjected to a force, the generally circular retainer comes into contact with the adaptor and the adaptor prevents any further movement of the generally circular retainer along the axis of the valve.

8. The valve of claim 7, wherein the retainer includes a pair of ends that define a gap therebetween.

9. The valve of claim 8, wherein in response to the force, the coupling member moves and the retainer moves to the open position, thereby leaving the annular groove of the coupling member and permitting the spool to move.

10. The valve of claim 4, further comprising a locking device engageable with the guide member to retain the valve in a selected position.

11. The valve of claim 10, wherein the selected position is a neutral position.

12. The valve of claim 3, wherein the valve is in a neutral position when the retainer is disposed in the annular groove.

12. The valve of claim 3, wherein the coupling member has a second annular groove and a third annular groove for respectively receiving the generally circular retainer in a first flow path position and a second flow path position.

13. The valve of claim 12, wherein the second and third grooves each have a depth less than the depth of the first annular groove.

14. The valve of claim 12, wherein the first flow path position defines a first flow path, the second flow path position defines a second flow path, the first flow path being different than the second flow path.

15. The valve of claim 4, wherein the coupling member has a second groove for receiving the generally circular retainer in a first flow path position.

16. The valve of claim 10, wherein the locking device is a hitch pin clip.

17. The valve of claim 11, wherein the locking device is a hitch pin clip.
